(19) United States
(12) Patent Application Publication
(10) Pub. No.: US 2026/0356277 A1
(43) Pub. Date: Nov. 12, 2026

(54) MULTI-CONFIGURABLE RAIL MOUNTING SYSTEM, METHODS, AND DEVICES

(71) Applicant: DECKED LLC, Ketchum, ID (US)

(72) Inventors: Brian Stevens, Ketchum, ID (US); Aaron Finch, Ketchum, ID (US); Dave Madaras, Ketchum, ID (US); Bill Banta, Ketchum, ID (US); Kreg Braunberger, Ketchum, ID (US); Spencer Dahl, Ketchum, ID (US)

(21) Appl. No.: 19/203,307

(22) Filed: May 9, 2025

(51) Int. Cl. B60P 7/15

(52) U.S. Cl. CPC B60P 7/15

(57) ABSTRACT

Systems, methods, and devices disclosed herein include a customizable rail mounting system and a corresponding method of manufacture. The customizable rail mounting system includes a cross-bar having one or more mounting channels, and a pair of cross-bar mounting feet. The pair of cross-bar mounting feet are operable to couple the cross-bar to a rail system disposed around a perimeter edge of a truck bed (e.g., truck bed slide). An individual cross-bar mounting foot of the pair of cross-bar mounting feet includes a base portion and a receiver. The receiver is defined by a plurality of sidewalls extending vertically from the base portion. A first sidewall of the plurality of sidewalls includes first two mounting holes and a second sidewall of the plurality of sidewalls includes second two mounting holes. The plurality of sidewalls define an interior space of the receiver for receiving an end of the cross-bar.

### BACKGROUND

Truck beds come in different shapes and sizes and are used for transporting a wide variety of items. Accessories that mount to truck beds provide additional utility and, similarly, come in a variety of configurations. Most accessories have a particular utility designed for certain use-cases, which can render the truck bed ineffective for other uses.

It is with these considerations in mind that the presently disclosed technology was conceived.

### SUMMARY

Systems, methods, and devices disclosed herein can address the aforementioned issues. For instance, a customizable, multi-configurable, and adjustable rail mounting system can include a cross-bar having one or more mounting channels. The rail mounting system can additionally include a pair of cross-bar mounting feet operable to couple the cross-bar to a rail system. The rail system can be disposed around a perimeter edge of a truck bed, around a truck bed slide, and/or around other cargo support rails of a truck. Furthermore, an individual cross-bar mounting foot of the pair of cross-bar mounting feet can include a base portion and a receiver. The receiver can be defined by a plurality of sidewalls extending vertically from the base portion. A first sidewall of the plurality of sidewalls can include two mounting holes. Additionally, the plurality of sidewalls can terminate to define a top opening of the receiver.

In some examples, the two mounting holes can be vertically aligned on the first sidewall. The two mounting holes can be first two mounting holes, and the receiver can include a second sidewall of the plurality of sidewalls having second two mounting holes aligned across the receiver with the first two mounting holes. Additionally, the system can include a bolt (e.g., with a drop-in T-slot nut) operable to selectively engage with either of the two mounting holes and the one or more mounting channels of the cross-bar to position the cross-bar at a selected height. The plurality of sidewalls can also include at least two planar sidewalls defining a receiver opening operable to receive an end of the cross-bar. Furthermore, the base portion can be formed by an upper shelf extending from an elongated body.

In some instances, the elongated body can include a slanted chamfer surface between a horizontal top surface of the upper shelf and a vertical side surface of the elongated body. Also, the first sidewall and a second sidewall of the receiver can extend perpendicularly to the upper shelf and the slanted chamfer surface. Additionally, a third sidewall forming a back of the receiver, opposite a receiver opening, can extend along a length of the upper shelf. Moreover, the first sidewall and the second sidewall of the receiver can include angled top portions providing a tapered top width of the receiver. The cross-bar can also be operable to extend past a horizontal plane defined by the top opening of the receiver when the cross-bar is coupled to the receiver.

In some scenarios, a customizable rail mounting system can include a cross-bar having one or more mounting channels. The customizable rail mounting system can also include a pair of cross-bar mounting feet operable to couple the cross-bar to a rail system disposed around a perimeter edge of a truck bed or a truck bed slide. An individual cross-bar mounting foot of the pair of cross-bar mounting feet can include a base portion and a receiver. The receiver can be defined by a plurality of sidewalls extending vertically from the base portion. A first sidewall of the plurality of sidewalls can include first one or more mounting holes. A second sidewall of the plurality of sidewalls can include second one or more mounting holes. A third sidewall of the plurality of sidewalls can define a back of the receiver.

In some examples, the plurality of sidewalls can terminate to define a top opening of the receiver. Additionally, a divider panel can be formed by a planar sheet. The divider panel can include one or more panel mounting holes operable for mating the divider panel to the one or more mounting channels of the cross-bar. Moreover, the one or more panel mounting holes can include at least two vertically elongated holes operable for receiving a mounting bolt to couple the divider panel to the cross-bar at a selected height. The one or more mounting channels can be operable to receive a nut-and-bolt (e.g., a bolt with a drop-in t-slot nut). Also, the mounting channels can include a first mounting channel extending along a first side of the cross-bar, a second mounting channel extending along a second side of the cross-bar opposite the first side, and/or a third mounting channel extending along a top of the cross-bar. Furthermore, the cross-bar can include a concave surface between the first mounting channel and the third mounting channel.

In some instances, a method of manufacturing a customizable rail mounting system can include forming a cross-bar having one or more mounting channels, and forming a cross-bar mounting foot operable to couple the cross-bar to a rail system disposed around a perimeter edge of a truck bed, a truck bed slide, or another cargo support feature. The cross-bar mounting foot can include a base portion having an upper shelf extending from an elongated body. Also, the cross-bar mounting foot can include a receiver formed by a plurality of sidewalls extending vertically from the base portion. The plurality of sidewalls can define an interior area of the receiver operable to receive an end of the cross-bar. Additionally, the method can include forming first two mounting holes into a first sidewall of the plurality of sidewalls, and/or forming second two mounting holes into a second sidewall of the plurality of sidewalls. Furthermore, the method can include forming one or more protrusions into the plurality of sidewalls, extending into the interior area of the receiver, and operable to mate with an end of the cross-bar. Moreover, the method can include forming a divider panel from sheet metal by creating at least two vertically elongated openings in the sheet metal. The at least two vertically elongated openings can be operable to receive a bolt or other attachment mechanism (e.g., a bolt with a drop-in t-slot nut) to attach the divider panel to the one or more mounting channels of the cross-bar at a selected height.

### BRIEF DESCRIPTION OF THE FIGURES

FIGS. 1A and 1B illustrate an example customizable rail mounting system for attaching a cross-bar to a perimeter edge of a truck bed or truck bed slide.

FIGS. 2A and 2B illustrate an example customizable rail mounting system for attaching a cross-bar to a perimeter edge of a truck bed or truck bed slide using one or more cross-bar mounting feet.

FIG. 3 illustrates an example customizable rail mounting system for attaching a cross-bar to a perimeter edge of a truck bed or truck bed slide by securing an end of the cross-bar into a cross-bar mounting foot.

FIG. 4 illustrates an example customizable rail mounting system for attaching a cross-bar to a perimeter edge of a truck bed or truck bed slide including a divider panel.

FIG. 5 illustrates an example method of manufacturing the customizable rail mounting system(s) disclosed herein regarding FIGS. 1A–4.

### DETAILED DESCRIPTION

It will be appreciated that numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

The systems, methods, and devices disclosed herein include a customizable rail mounting system with multiple configuration options. The customizable rail mounting system can include one or more cross-bars which adjustably mount to a perimeter edge of a truck bed, a truck bed slide, or other cargo support rails of a truck using a plurality of cross-bar mounting feet. For instance, a first pair of cross-bar mounting feet can be used to attach a first cross-bar to the perimeter edge, and a second pair of cross-bar mounting feet can be used to attach a second cross-bar to the perimeter edge. Additionally, the customizable rail mounting system can also include one or more divider panels which couple to the cross-bar(s).

Furthermore, an individual cross-bar mounting foot of the pair of cross-bar mounting feet can include features that simplify an installation process for the system while providing multiple installation configuration options. For example, the cross-bar mounting foot can include a base portion and a receiver. The base portion can have coupling holes for attaching the receiver to the perimeter edge at any position along a longitudinal length of the truck bed. Additionally, the receiver can be defined by a plurality of sidewalls extending vertically from the base portion with multiple different coupling hole options formed into the sidewalls. Accordingly, the positions and heights of the cross-bars and the divider panels can be easily adjusted while maintaining a structural integrity of the customizable rail mounting system.

Additional advantages of the systems, methods, and devices discussed herein will become apparent from the detailed description below.

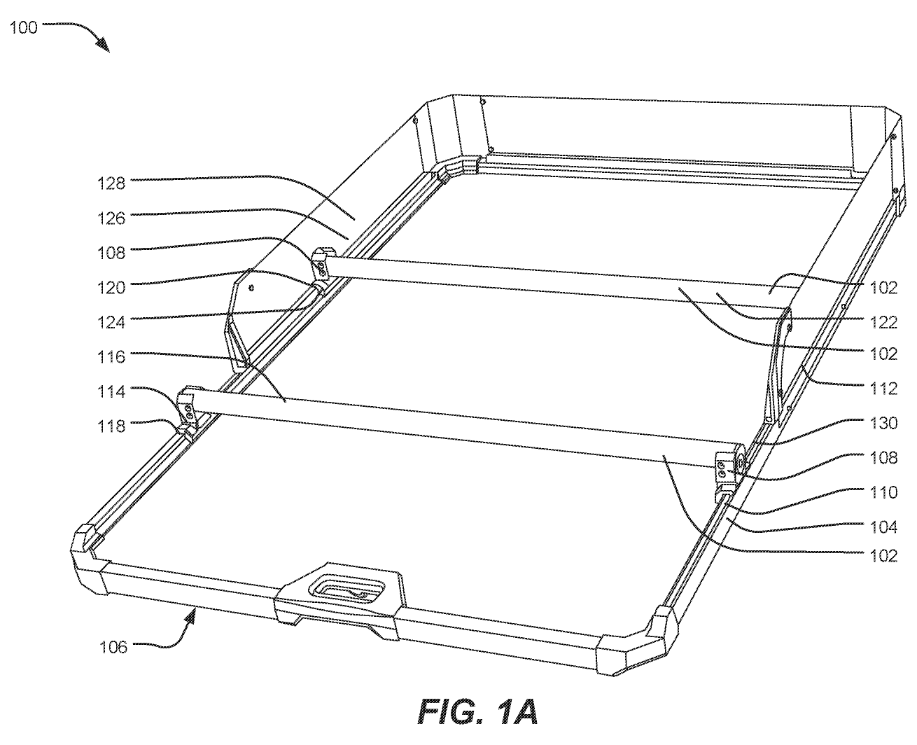

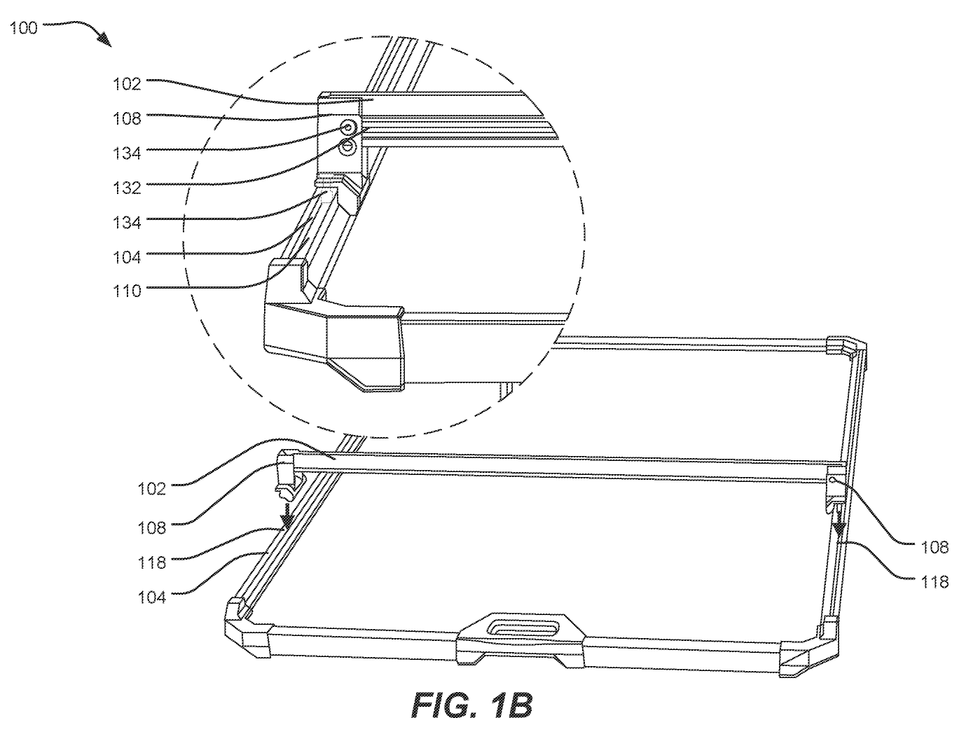

FIGS. 1A and 1B illustrate example customizable rail mounting system(s) 100 (“system”) for attaching a cross-bar 102 to a perimeter edge 104, such as the perimeter edge 104 of a truck bed 106 (e.g., a truck bed slide, cargo support rails, or so forth). In some scenarios, the system(s) 100 can include various adjustable components and features that provide customizable configurations to match a plurality of different shapes, sizes, and use-cases, as discussed herein.

In some examples, the system(s) 100 can include one or more cross-bar mounting feet 108 operable to couple the cross-bar 102 to the perimeter edge 104. The perimeter edge 104 can be a terminating edge of the truck bed 106 and/or can include a rail system 110 installed onto the truck bed 106. By using the cross-bar mounting feet 108, the cross-bar 102 can be installed onto the truck bed 106 at any position along a longitudinal length 112 of the truck bed 106. Furthermore, as discussed in greater detail below, the cross-bar mounting feet 108 and/or the cross-bar 102 can include features that provide an adjustable (e.g., “selectable”) height of the cross-bar 102. This can be beneficial in situations where multiple cross-bars 102 are installed onto the perimeter edge 104 at different locations. A first location 114 of a first cross-bar 116 can include a direct connection 118 to the rail system 110, and a second location 120 of the second cross-bar 122 can include an overlapped connection 124 in which another accessory 126 (e.g., an extension panel 128) is already coupled to the rail system 110, and the cross-bar mounting foot 108 attaches on top of the other accessory 126. By using the disclosed technology, a height of the second cross-bar 122 disposed over the other accessory 126 (e.g., an “already-coupled” component), can be adjusted down to compensate for the additional height added by the other accessory 126, such that the height of the second cross-bar 122 matches a height of the first cross-bar 116. In this way, the heights of the first cross-bar 116 and the second cross-bar 122 can ultimately be the same, even though the second cross-bar 122 has the overlapped connection 124 with the other accessory 126, and the first cross-bar 116 has the direct connection 118.

In some instances, the rail system 110 disposed around the perimeter 104 can include a T-slot channel 130. Furthermore, the cross-bar 102 can include one or more mounting channels 132, which can also be T-slot channels 130. As such, hardware requirements for attaching and/or adjusting the components of the customizable rail mounting system(s) 100 can be simplified. For instance, one or more bolt(s) 134 (e.g., with a drop-in T-slot nut) can be used to couple the cross-bar 102 to the cross-bar mounting feet 108, and/or to couple the cross-bar mounting feet 108 to the rail system 110 along the perimeter edge 104. Furthermore, the bolts 134 can be used to adjust a position of the cross-bar mounting feet 108 once installed, for example, by loosening the drop-in T-slot nut attached to the bolt 134, sliding the cross-bar mounting feet 108 along the T-slot channel 130 on the perimeter edge 104, and/or retightening the drop-in T-slot nut attached to the bolt 134.

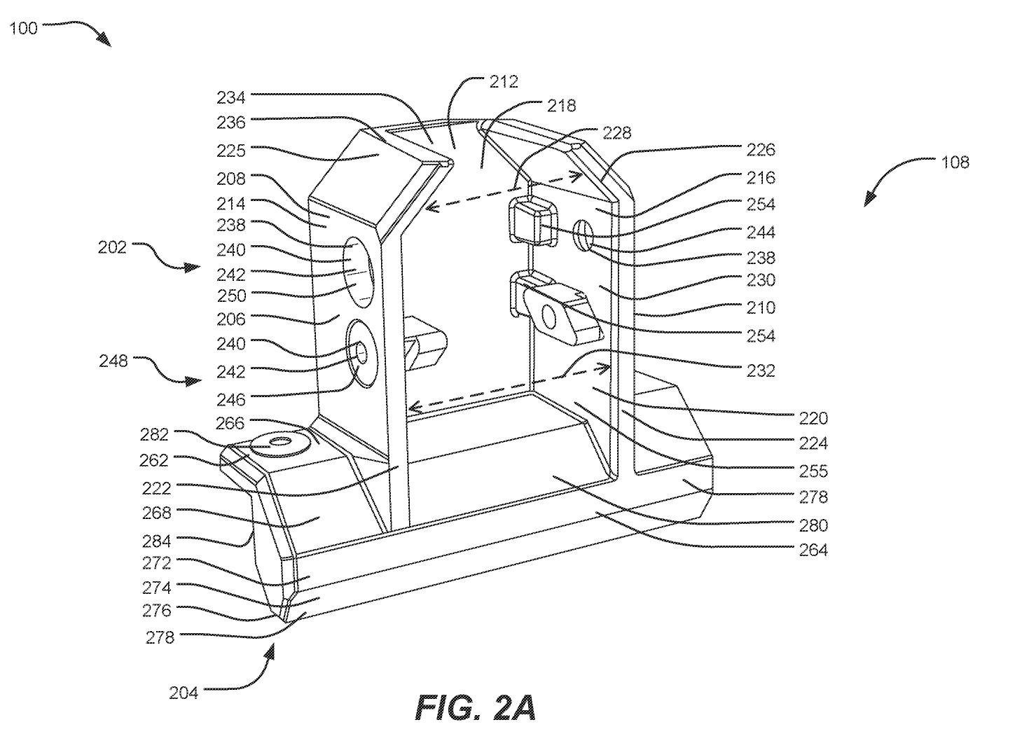

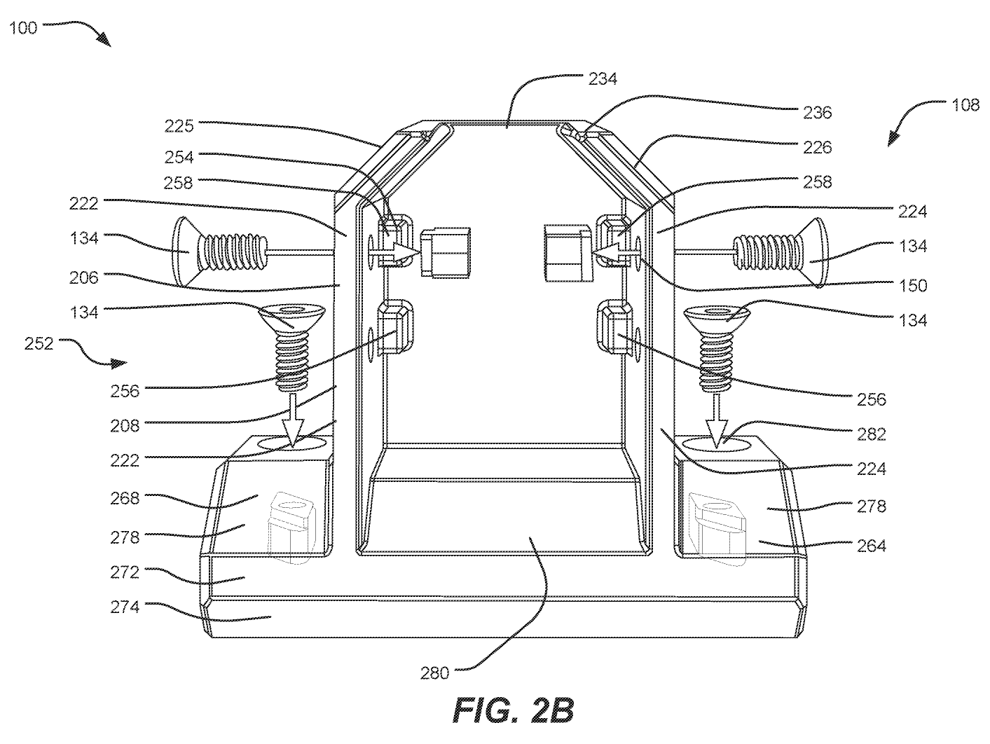

FIGS. 2A and 2B illustrate an example customizable rail mounting system(s) 100 for attaching a cross-bar 102 to a perimeter edge 104 using one or more (e.g., a pair) of cross-bar mounting feet 108. As depicted in FIGS. 2A and 2B, an individual cross-bar mounting foot 108 can include a receiver 202 extending from a base portion 204. The system(s) 100 depicted in FIGS. 2A and 2B can be similar to, identical to, and/or can form at least a portion of the system(s) 100 depicted in FIGS. 1A and/or 1B.

In some examples, the receiver 202 of the cross-bar mounting foot 108 can be defined by a plurality of sidewalls 206. The plurality of sidewalls 206 can include a first sidewall 208, a second sidewall 210, and/or a third sidewall 212. The plurality of sidewalls 206 can be formed of a substantially flat and/or planar material (e.g., metal, plastic, carbon fiber, ceramics, and/or combinations thereof) with flat outer surfaces 214. Furthermore, the plurality of sidewalls 206 can define an interior area 216 for receiving an end of the cross-bar 102. For instance, the third sidewall 212 can be disposed between and/or can connect the first sidewall 208 to the second sidewall 210 at one end of the receiver 202, such that the third sidewall defines a rear surface 218 of the receiver 202. A receiver opening 220 can be defined between the first sidewall 208 and the second sidewall 210, between a first terminating edge 222 of the first sidewall 208 and a second terminating edge 225 of the second sidewall 210, and/or at an opposite side of the receiver 202 from the rear surface 218. The receiver opening 220 can be operable to provide access to the interior area 216 for the end of the cross-bar 102. Moreover, the first sidewall 208 and/or the second sidewall 210 can include a first angled top portion 225 and/or a second angled top portion 226, respectively. The first angled top portion 225 and the second angled top portion 226 can extend inward towards each other such that the receiver 202 and/or the receiver opening 220 have a tapered top width dimension 228. In contrast, the portions 230 of the first sidewall 208 and/or the second sidewall 210 below the first angled top portion 225 and/or the second angled top portion 226 can be substantially vertical and/or parallel to each other, such that this portion 230 has a constant width dimension 232. Furthermore, the receiver 202 can have a top opening 234 defined by terminating edges 236 of the plurality of sidewalls 206 (e.g., the first angled top portion 225 of the first sidewall 208, the second angled top portion 226 of the second sidewall 210, and/or the third sidewall 212).

In some instances, the receiver 202 can include one or more mounting hole(s) 238 formed into the first sidewall 208 and/or the second sidewall 210. The mounting holes(s) 238 can include a first set 240 of two mounting holes 242 formed into the first sidewall 208 and/or a second set 244 of two mounting holes 242 formed into the second sidewall 210. The two mounting holes 242 can be vertically aligned with each other, or the two mounting holes 242 can be vertically off-set from each other. Additionally, the first set 240 of mounting hole(s) 238 on the first sidewall 208 can be horizontally aligned, across the receiver 202 (e.g., across the interior area 216), with the second set 244 of mounting hole(s) 238.

In some scenarios, the configuration of mounting holes 238 disclosed herein can provide multiple mounting configuration options for mounting the cross-bar 102. For instance, the cross-bar 102 can be coupled to the lower mounting hole(s) 246 in a first configuration 248 (e.g., FIG. 2A) such that the height of the cross-bar 102 is selected to be a lower height option. Additionally, the cross-bar 102 can be coupled to the upper mounting hole(s) 250 in a second configuration 252 (e.g., FIG. 2B) such that the height of the cross-bar 102 is selected to be a higher height option. It is to be understood that the receiver 202 can include any number of mounting holes 238 disposed on the first sidewall 208 (e.g., one, two, three, four, five, six, seven, eight, and so forth) to provide any number of selectable height configurations for the cross-bar 102.

In some examples, the receiver can include one or more protrusion(s) 254 formed into an interior surface 255 of the first sidewall 208 and/or the second sidewall 210. The protrusion(s) 254 can be formed into corners of the interior area 216 where the third sidewall 212 meets the first sidewall 208 and/or the second sidewall 210. Furthermore, the protrusion(s) 254 can include a first set of lower protrusions 256 with one protrusion 254 extending from the first sidewall 208 and another protrusion 254 extending from the second sidewall 210. Additionally, the protrusion(s) 254 can include a second set of upper protrusions 258, again, with one protrusion 254 extending from the first sidewall 208 and another protrusion 254 extending from the second sidewall 210. The protrusion(s) 254 can horizontally align with the mounting hole(s) 238. For instance, the lower protrusion(s) 256 can horizontally align with the lower mounting hole(s) 246 and/or the upper protrusion(s) 258 can align with the upper mounting hole(s) 250. In this way, when an end of the cross-bar 102 is inserted into the receiver opening 220 of the receiver 202, the protrusion(s) 254 can slide into the mounting channel(s) 132 disposed along the sides of the cross-bar 102, such that the cross-bar 102 can rest on the protrusion(s) 254. Accordingly, the cross-bar 102 can be held in place by the protrusion(s) 254 before, during, and/or after the cross-bar is secured in place by the bolts 134 being inserted through the mounting hole(s) 238 and into the mounting channel(s) 132, and/or the drop-in T-slot nuts attached to the bolts 134. The receiver can include any number of protrusion(s) 254 to match the number of mounting hole(s) 238.

In some instances, the cross-bar mounting foot 108 can include the base portion 204 disposed at least partly below the receiver 202. The base portion 204 can be formed by an upper shelf 262 extending from an elongated body 264. The upper shelf 262 can be a thinner top portion that juts horizontally from the elongated body 264 and can include a horizontal top surface 266. Also, the elongated body 264 can include a slanted chamfer surface 268 between the horizontal top surface 266 of the upper shelf 262 and a vertical side surface 272 of the elongated body 264. The terminating edges 236 of the first sidewall 208 and/or the second sidewall 210 can be flush with the vertical side surface 272. Moreover, the elongated body 264 can include a chamfered underside surface 274 transitioning between the vertical side surface 272 and a flat bottom surface 276.

In some scenarios, the first sidewall 208 and the second sidewall 210 can extend perpendicularly from the base portion 204 (e.g., from both the upper shelf 262 and the elongated body 264), dividing the base portion 204 into two outer ends 278 and a middle section 280. The third sidewall 212 can extend along a length of the upper shelf 262 at a back edge of the upper shelf 262. One or more coupling hole(s) 282 can be disposed on the horizontal top surface 266 of the upper shelf 262 at either or both of the outer ends 278. A coupling space 284 can be formed underneath the upper shelf 262 to receive the rail system 110 and/or the drop-in T-slot nuts attaching to the bolts 134 passing through the coupling hole(s) 282. Furthermore, in some cases, the horizontal top surface 266 at the middle section 280 can have a different height (e.g., higher or lower) than the horizontal top surface 266 at the outer ends 278.

In some examples, the cross-bar mounting foot 102 can be formed by cutting and/or bending a plurality of sheets of metal, and attaching these pieces of metal together (e.g., welding) to form the receiver 202. Additionally or alternatively, the receiver 202 can be formed via a casting process and/or a 3D-printing process. The base portion 204 can be formed by cutting and bending metal, via an extrusion process, a casting process, a 3D-printing process and/or combinations thereof. Then the receiver 202 can be attached (e.g., welded) to the base portion 204. The protrusions 254 can be attached to the interior surface 255 of the sidewalls 206, for instance via a welding process. The mounting hole(s) 238 and/or the coupling hole(s) 282 can be formed via a drilling and/or CNC cutting procedure. Also, in some instances, the receiver 202 and the base portion 204 can be formed as a single unit, for example, via a single casting process or a 3D printing process.

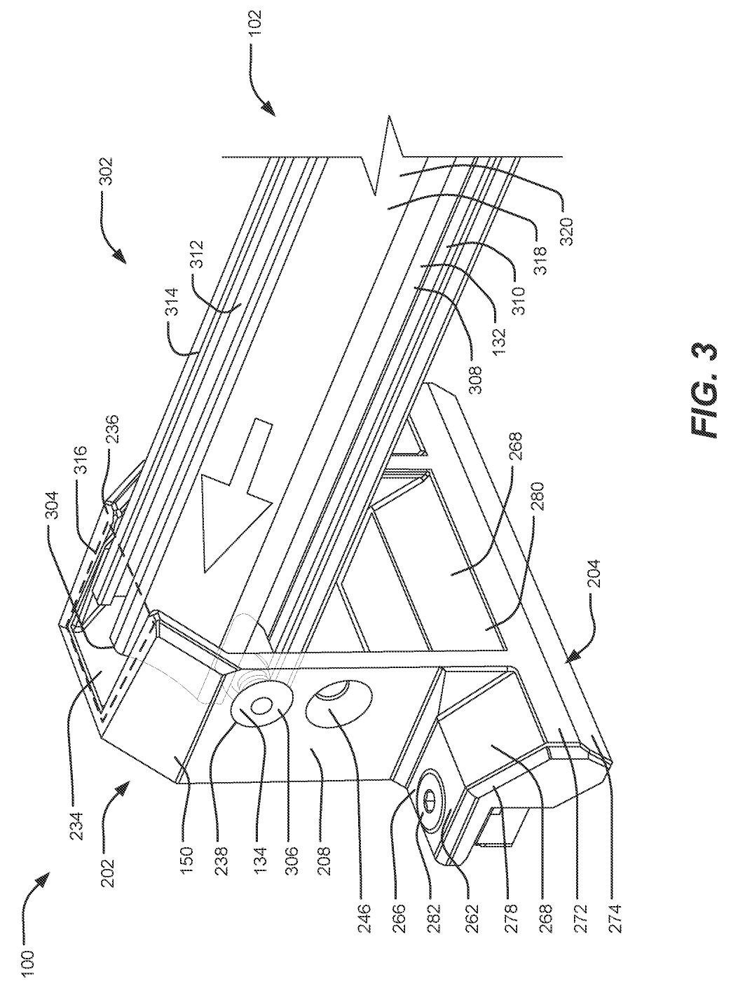

FIG. 3 illustrates an example customizable rail mounting system(s) 100 for attaching a cross-bar 102 to a perimeter edge 104 using cross-bar mounting feet 108. As depicted in FIG. 3, a mounting procedure 302 can include inserting an end 304 of the cross-bar 102 into the receiver 202 of a cross-bar mounting foot 108. The system(s) 100 depicted in FIG. 3 can be similar to, identical to, and/or can form at least a portion of the system(s) 100 depicted in FIGS. 1A and/or 1B.

In some scenarios, the cross-bar 102 can be formed of an elongated piece of metal or other rigid material (e.g., plastic, wood, carbon-fiber, and so forth) formed via an extrusion into the shape of the cross-bar 102. The mounting procedure 302 can include inserting the end 304 into the receiver opening 220, and securing the cross-bar 102 in place with one or more bolts 134 or other coupling mechanisms. For instance, a first bolt 306 can be inserted through one of the mounting holes 238 on the first sidewall 208 and into a first mounting channel 308 (e.g., a T-slot channel 130) extending along a first side 310 of the cross-bar 102. Additionally, a second bolt 134 can be inserted through one of the mounting holes 238 on the second sidewall 210 and into a second mounting channel extending along a second side of the cross-bar 102. The mounting hole(s) 238 can be selected from a plurality of mounting hole(s) 238 to determine a height of the cross-bar 102. Additionally, a third mounting channel 312 can be formed into a top surface 314 of the cross-bar 102 which provides additional equipment and/or accessory mounting options once the cross-bar 102 is secured in place.

In some cases, the top surface 314 of the cross-bar 102 can vertically extend past a horizontal plane 316 defined by the top opening 234 (e.g., by the terminating edges 236 of the plurality of sidewalls 206). In other words, a first distance value between the first mounting channel 308 and the top surface 314 of the cross-bar 102 can be greater than a second distance value between the mounting hole 238 and the terminating edges 236 defining the top opening 234 of the receiver 202. Certain use-cases can benefit from this configuration in which the top surface 314 of the cross-bar 102 extends beyond the top opening 234. For example, in scenarios involving two cross-bars 102 (e.g., FIG. 1A) in which a sheet product (e.g., plywood, dry wall, glass, sheet metal, etc.) and/or another elongated product (e.g., pipes, poles, lumber, and so forth) is laid and/or slid across the two cross-bars 102, the product can avoid catching on or getting scratched by the top of the cross-bar mounting foot 108 because the product will only contact the top surface 314 of the cross-bars 102. In other examples, the top surface 314 of the cross-bar can be flush with or below the horizontal plane 316 defined by the terminating edges 236.

In some examples, an outer surface 318 of the cross-bar 102 between the first mounting channel 308 and the top surface 314 can include a concave curve 320. This concave surface 320 can provide extra clearance for additional accessory connections to the cross-bar, such as hooks inserted into the first mounting channel 308. Another concave surface can be formed between the top surface 314 and the second mounting channel on the side opposite the first mounting channel 308.

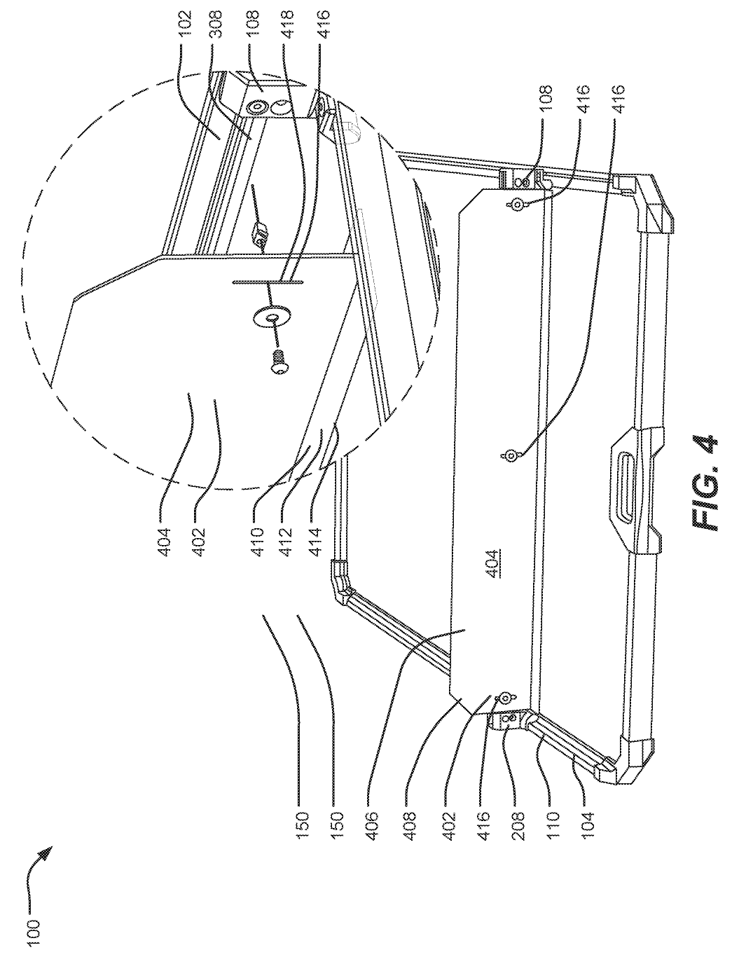

FIG. 4 illustrates an example customizable rail mounting system(s) 100 for attaching a cross-bar 102 to a perimeter edge 104 using cross-bar mounting feet 108. As depicted in FIG. 4, a divider panel 402 can couple to the cross-bar 102. The system(s) 100 depicted in FIG. 4 can be similar to, identical to, and/or can form at least a portion of the system(s) 100 depicted in FIGS. 1A and/or 1B.

In some instances, the divider panel 402 can be formed by cutting a planar sheet of metal 404 into an elongated shape 406, which can include slanted corners 408. Additionally, the sheet of metal 404 can be attached (e.g., welded) to a strip of metal 410 forming a divider foot 412. The divider foot 412 can form a flat bottom surface 414 of the divider panel 402, and can be substantially perpendicular to the divider panel 402.

In some examples, the divider panel 402 can include one or more panel mounting holes 416 for mating the divider panel 402 with the first mounting channel 308 of the cross-bar 102. The panel mounting hole(s) 416 can be formed via a drilling process, a laser cutting process, a CNC cutting process, and/or any combination thereof. Furthermore, the panel mounting hole(s) 416 can include vertically elongated hole(s) 418 such that a mounting height of the divider panel 402 can be adjustable to match the particular use-case. For instance, securing the divider panel 402 using a top portion of the vertically elongated hole 418 can result in a lower divider panel height, whereas using a lower portion of the vertically elongated hole 418 can result in a higher divider panel height. Moreover, the divider panel 402 can include at least two panel mounting hole(s) 416, three panel mounting hole(s) 416, or any number of panel mounting hole(s) 416.

In some instances, the divider panel 402 can be used to divide a space of the truck bed 106 into separated compartments. The divider panel 402 can be attached to either side of the cross-bar 102 using the first mounting channel 308 or the second mounting channel. The location and height of the divider panel 402 can be selected and/or adjusted to match the needs of a user of the customizable rail mounting system(s) 100. Furthermore, it is to be understood that the system(s) 100 can include multiple divider panel(s) 402. For instance, in scenarios involving two cross-bars 102, a first divider panel 402 can be coupled to the first cross-bar 116 and a second divider panel 402 can be coupled to the second cross-bar 122. It is to be understood that the customizable rail mounting system(s) 100 can include any number of cross-bars 102 (e.g., one, two, three, four, five, six, etc.) and any number of divider panels 402 (e.g., one, two, three, four, five, six, etc.) to match the needs of the user’s particular situation.

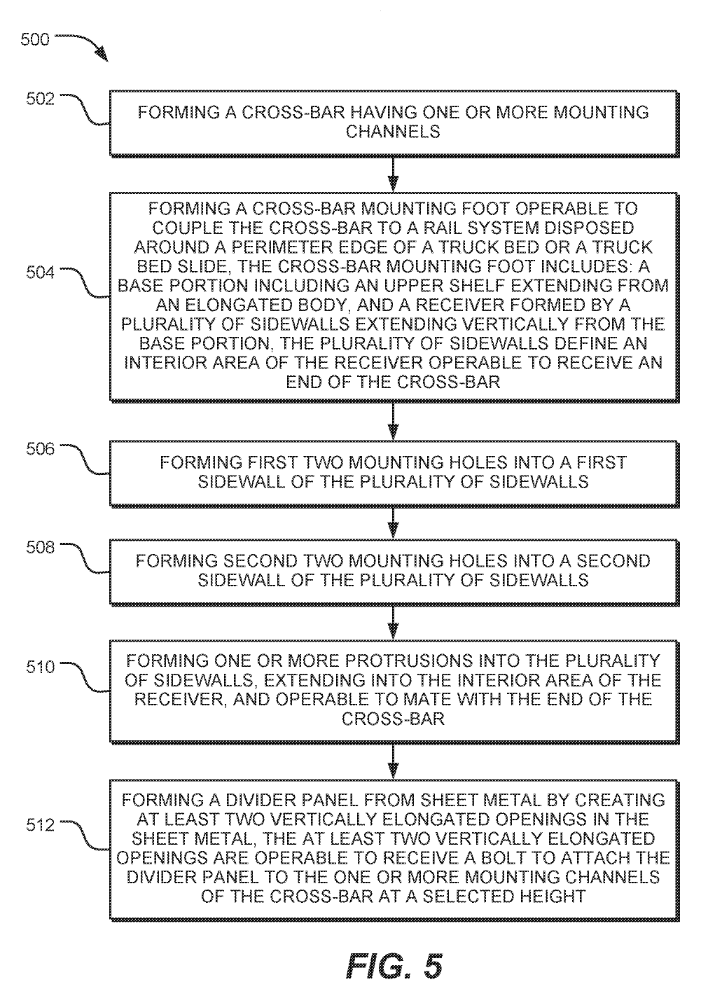

FIG. 5 depicts an example method 500 of manufacturing a customizable rail mounting system 100, such as the customizable rail mounting system(s) 100 depicted in FIGS. 1A–4.

In some examples, at operation 502, the method 500 can form a cross-bar having one or more mounting channels. At operation 504, the method 500 can form a cross-bar mounting foot operable to couple the cross-bar to a rail system disposed around a perimeter edge of a truck bed or a truck bed slide. The cross-bar mounting foot can include a base portion having an upper shelf extending from an elongated body, and a receiver formed by a plurality of sidewalls extending vertically from the base portion. The plurality of sidewalls can define an interior area of the receiver operable to receive an end of the cross-bar. At operation 506, the method 500 can form first two mounting holes into a first sidewall of the plurality of sidewalls. At operation 508, the method 500 can form second two mounting holes into a second sidewall of the plurality of sidewalls. At operation 510, the method 500 can form one or more protrusions into the plurality of sidewalls, extending into the interior area of the receiver, and operable to mate with an end of the cross-bar. At operation 512, the method 500 can form a divider panel from sheet metal by creating at least two vertically elongated openings in the sheet metal, the at least two vertically elongated openings are operable to receive a bolt to attach the divider panel to the one or more mounting channels of the cross-bar at a selected height.

It is to be understood that the specific order or hierarchy of steps in the methods depicted throughout this disclosure are instances of example approaches and can be rearranged while remaining within the disclosed subject matter. For instance, any of the operations discussed throughout this disclosure may be omitted, repeated, performed in parallel, performed in a different order, and/or combined with any other of the operations discussed throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. Any component or feature of one example can be combined with any component or feature of any other example. These and other variations, modifications, additions, and improvements may fall within the scope of the disclosure as defined in the claims that follow.

What is claimed is:

1. A customizable rail mounting system comprising:
a cross-bar having one or more mounting channels; and
a pair of cross-bar mounting feet operable to couple the cross-bar to a rail system disposed around a perimeter edge of a truck bed or a truck bed slide, an individual cross-bar mounting foot of the pair of cross-bar mounting feet includes:
a base portion, and
a receiver defined by a plurality of sidewalls extending vertically from the base portion, a first sidewall of the plurality of sidewalls includes two mounting holes, and the plurality of sidewalls terminate to define a top opening of the receiver.

2. The system of claim 1, wherein:
the two mounting holes are vertically aligned on the first sidewall.

3. The system of claim 1, wherein:
the two mounting holes are first two mounting holes, and
the receiver includes a second sidewall of the plurality of sidewalls having second two mounting holes aligned across the receiver with the first two mounting holes.

4. The system of claim 1, further comprising:
a bolt operable to selectively engage with either of the two mounting holes and the one or more mounting channels of the cross-bar to position the cross-bar at a selected height.

5. The system of claim 1, wherein:
the plurality of sidewalls include at least two planar sidewalls defining a receiver opening operable to receive an end of the cross-bar.

6. The system of claim 1, wherein:
the base portion is formed by an upper shelf extending from an elongated body.

7. The system of claim 6, wherein:
the elongated body includes a slanted chamfer surface between a horizontal top surface of the upper shelf and a vertical side surface of the elongated body.

8. The system of claim 7, wherein:
the first sidewall and a second sidewall of the receiver extend perpendicularly to the upper shelf and the slanted chamfer surface, and
a third sidewall forming a back of the receiver opposite a receiver opening extends along a length of the upper shelf.

9. The system of claim 1, wherein:
the first sidewall and a second sidewall of the receiver include angled top portions providing a tapered top width of the receiver.

10. The system of claim 1, wherein:
the cross-bar is operable to extend past a horizontal plane defined by the top opening of the receiver when the cross-bar is coupled to the receiver.

11. A customizable rail mounting system comprising:
a cross-bar having one or more mounting channels; and
a pair of cross-bar mounting feet operable to couple the cross-bar to a rail system disposed around a perimeter edge of a truck bed or a truck bed slide, an individual cross-bar mounting foot of the pair of cross-bar mounting feet includes:
a base portion, and
a receiver defined by a plurality of sidewalls extending vertically from the base portion, a first sidewall of the plurality of sidewalls includes first one or more mounting holes, a second sidewall of the plurality of sidewalls includes second one or more mounting holes, and a third sidewall of the plurality of sidewalls defines a back of the receiver.

12. The system of claim 11, wherein:
the plurality of sidewalls terminate to define a top opening of the receiver.

13. The system of claim 11, further comprising:
a divider panel formed by a planar sheet, the divider panel including one or more panel mounting holes operable for mating the divider panel to the one or more mounting channels of the cross-bar.

14. The system of claim 13, wherein:
the one or more panel mounting holes include at least two vertically elongated holes operable for receiving a mounting bolt to couple the divider panel to the cross-bar at a selected height.

15. The system of claim 11, wherein:
the one or more mounting channels are operable to receive a bolt and include:
a first mounting channel extending along a first side of the cross-bar,
a second mounting channel extending along a second side of the cross-bar opposite the first side, and
a third mounting channel extending along a top of the cross-bar.

16. The system of claim 15, wherein:
the cross-bar includes a concave surface between the first mounting channel and the third mounting channel.

17. A method of manufacturing a customizable rail mounting system comprising:
forming a cross-bar having one or more mounting channels; and
forming a cross-bar mounting foot operable to couple the cross-bar to a rail system disposed around a perimeter edge of a truck bed or a truck bed slide, the cross-bar mounting foot includes:
a base portion including an upper shelf extending from an elongated body, and
a receiver formed by a plurality of sidewalls extending vertically from the base portion, the plurality of sidewalls define an interior area of the receiver operable to receive an end of the cross-bar.

18. The method of claim 17, further comprising:
forming first two mounting holes into a first sidewall of the plurality of sidewalls, and
forming second two mounting holes into a second sidewall of the plurality of sidewalls.

19. The method of claim 17, further comprising:
forming one or more protrusions into the plurality of sidewalls, extending into the interior area of the receiver, and operable to mate with the end of the cross-bar.

20. The method of claim 17, further comprising:
forming a divider panel from sheet metal by creating at least two vertically elongated openings in the sheet metal, the at least two vertically elongated openings are operable to receive a bolt to attach the divider panel to the one or more mounting channels of the cross-bar at a selected height.
